(19) United States
(12) Patent Application Publication
(10) Pub. No.: US 2018/0032124 A1
(43) Pub. Date: Feb. 1, 2018

(54) POWER CONTROL CONTROLLER, SEMICONDUCTOR DEVICE, AND SEMICONDUCTOR SYSTEM

(71) Applicant: Renesas Electronics Corporation, Tokyo (JP)

(72) Inventor: Kazuki FUKUOKA, Tokyo (JP)

(21) Appl. No.: 15/496,341

(22) Filed: Apr. 25, 2017

(30) Foreign Application Priority Data
Jul. 26, 2016 (JP) 2016-145960

(51) Int. Cl. G06F 1/32; H02M 3/157; H02M 3/158

(52) U.S. Cl. CPC G06F 1/3296; H02M 3/158; H02M 3/157; G06F 1/3287; G06F 1/3206

(57) ABSTRACT

An object of the present invention is to finely adjust a voltage for each processor core. A semiconductor system includes a semiconductor device and a power supply device configured to supply a fixed voltage to a supply voltage line. The semiconductor device includes a plurality of power control controllers. Each of the plurality of power control controllers includes a processor core, a plurality of switch transistors connected in parallel between the supply voltage line and a control voltage line, the control voltage line supplying a power supply voltage to the processor core, an AD converter configured to convert a control voltage output from the control voltage line into a current voltage value, the current voltage value being a digital value, and a step-down controller configured to control the plurality of switch transistors in order to bring the converted current voltage value close to a target voltage value.

### CROSS-REFERENCE TO RELATED APPLICATIONS

This application is based upon and claims the benefit of priority from Japanese patent application No. 2016-145960, filed on Jul. 26, 2016, the disclosure of which is incorporated herein in its entirety by reference.

### BACKGROUND

The present invention relates to a power control controller, a semiconductor device, and a semiconductor system, and to, for example, a power control controller, a semiconductor device, and a semiconductor system that perform power control.

Japanese Unexamined Patent Application Publication No. 2006-339507 (Patent Literature 1) discloses a technique relating to a driving circuit. The driving circuit according to Japanese Unexamined Patent Application Publication No. 2006-339507 controls a current (voltage) applied to a load 3 by PWM (Pulse Width Modulation)-controlling a gate signal of an output transistor M1 according to a drain voltage of the output transistor M1.

Japanese Unexamined Patent Application Publication No. 2011-193555 (Patent Literature 2) discloses a technique relating to a voltage variable circuit. In the voltage variable circuit disclosed in Japanese Unexamined Patent Application Publication No. 2011-193555, a power supply controller 203 firstly controls a voltage to be output to an output power line 204a according to a voltage of an input power line 204b. Then, the voltage variable circuit 204 individually controls output voltages for resistors Ra1, Ra2, and Ra3 according to control signals A, B, and C, respectively.

Japanese Unexamined Patent Application Publication No. 2010-130825 (Patent Literature 3) discloses a technique relating to a switching power device. In the switching power device disclosed in Japanese Unexamined Patent Application Publication No. 2010-130825, transistors M1 and M2 are operated complementarily to each other by a PWM signal generated according to an output feedback voltage Vfb. Further, the current capability of the transistors M1 and M2 is variably controlled according to a current value output to a load.

### SUMMARY

The inventor has found a problem in that, with the step-down circuit for controlling the gate voltage by analog control used in the techniques disclosed in Japanese Unexamined Patent Application Publication Nos. 2006-339507, 2011-193555, and 2010-130825, it is difficult to control a large number of switch transistors.

Other problems of the related art and new features of the present invention will become apparent from the following descriptions of the specification and attached drawings.

In an example aspect, a power control controller includes a plurality of switch transistors connected in parallel between a supply voltage line and a control voltage line and controls the plurality of switch transistors in order to bring a current voltage value, which is obtained by converting a control voltage from analog to digital, close to a target voltage value.

In another example aspect, a semiconductor device includes a plurality of power control controllers. Each of the plurality of power control controller includes: a processor core; a plurality of switch transistors connected in parallel between a supply voltage line and a control voltage line; an AD converter configured to convert a control voltage into a current voltage value from analog to digital; a storage unit configured to store a plurality of target voltage values each associated with a combination of a fuse setting value and a clock frequency; and a step-down controller configured to control the plurality of switch transistors in order to bring the converted current voltage value close to a target voltage value, wherein a plurality of the storage units included respectively in the plurality of power control controller have different specified values from one another.

In still another example aspect, a semiconductor system includes a semiconductor device and a power supply device. The semiconductor device includes a plurality of power control controllers. Each of the plurality of power control controller includes: a processor core; a plurality of switch transistors connected in parallel between a supply voltage line and a control voltage line; an AD converter configured to convert a control voltage output from the control voltage line into a current voltage value from analog to digital; and a step-down controller configured to control the plurality of switch transistors in order to bring the converted current voltage value close to a target voltage value. The power supply device is configured to supply a fixed voltage to the supply voltage line.

According to the above example aspects, it is possible to finely adjust voltages for respective processor cores.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a semiconductor system according to a first embodiment;

FIG. 2 is a drawing showing an example of a target voltage value setting table according to the first embodiment.

FIG. 3 is a block diagram showing a configuration of a power control controller according to the first embodiment.

FIG. 4 is a drawing showing a configuration relating to a first feedback loop of the power control controller according to the first embodiment.

FIG. 5 is a drawing for describing a concept including an example of a droop monitor according to the first embodiment.

FIG. 6 is a drawing showing an example of a delay monitor according to the first embodiment.

FIG. 7 is a flowchart for describing a flow of a process of the delay monitor according to the first embodiment.

FIG. 8 is a flowchart for describing a flow of a process of a second feedback loop according to the first embodiment.

FIG. 9 is a drawing showing an example of a reliability monitor according to the first embodiment.

FIG. 10 is a flowchart for describing a flow of a process of the reliability monitor according to the first embodiment.

FIG. 11 is a drawing for describing a concept of a process of a third feedback loop according to the first embodiment.

FIG. 12 is a drawing showing an example of operation modes according to the first embodiment.

FIG. 13 is a drawing showing an example of transitions of the operation modes according to the first embodiment.

FIG. 14 is a drawing for describing a concept of a dual-core operation according to the first embodiment.

FIG. 15 is a drawing for describing a concept of single-core power off according to the first embodiment.

FIG. 16 is a drawing for describing a concept of single-core power retention according to the first embodiment.

FIG. 17 is a drawing for describing a concept of all-core power retention according to the first embodiment.

FIG. 18 is a drawing for describing a concept of all-core power off according to the first embodiment.

FIG. 19 is a block diagram showing another configuration of the power control controller according to the first embodiment.

FIG. 20 is a drawing showing a configuration relating to a process when a power switch of a power control controller according to a second embodiment is turned on.

FIG. 21 is a drawing showing examples of respective signals when the power switch is turned on according to the second embodiment.

FIG. 22 is a block diagram showing a configuration of a semiconductor system according to a third embodiment.

FIG. 23 is a block diagram relating to control of a power supply voltage of a multi-core system according to related art

### DETAILED DESCRIPTION

Hereinafter, specific embodiments to which the means for solving the above-described problem is applied will be described in detail with reference to the drawings. In the drawings, the same elements are denoted by the same reference signs, and repeated descriptions are omitted for clarity of the description.

The invention will be described by dividing it into a plurality of sections or embodiments whenever circumstances require it for convenience in the following embodiments. However, unless otherwise particularly specified, these sections or embodiments are not irrelevant to one another. One section or embodiment is related to modifications, applications, details, supplementary explanations, and the like of some or all of the other ones. When reference is made to the number of elements or the like (including the number of pieces, numerical values, quantity, range, etc.) in the following embodiments, the number thereof is not limited to a specific number and may be greater than or less than or equal to the specific number unless otherwise particularly specified and definitely limited to the specific number in principle.

Further, in the following embodiments, components (including operation steps, etc.) are not always essential unless otherwise particularly specified and considered to be definitely essential in principle. Similarly, when reference is made to the shapes, positional relations, and the like of the components or the like in the following embodiments, they will include ones, for example, substantially approximate or similar in their shapes or the like unless otherwise particularly specified and considered not to be definitely so in principle. This is similarly applied even to the above-described number or the like (including the number of pieces, numerical values, quantity, range, etc.).

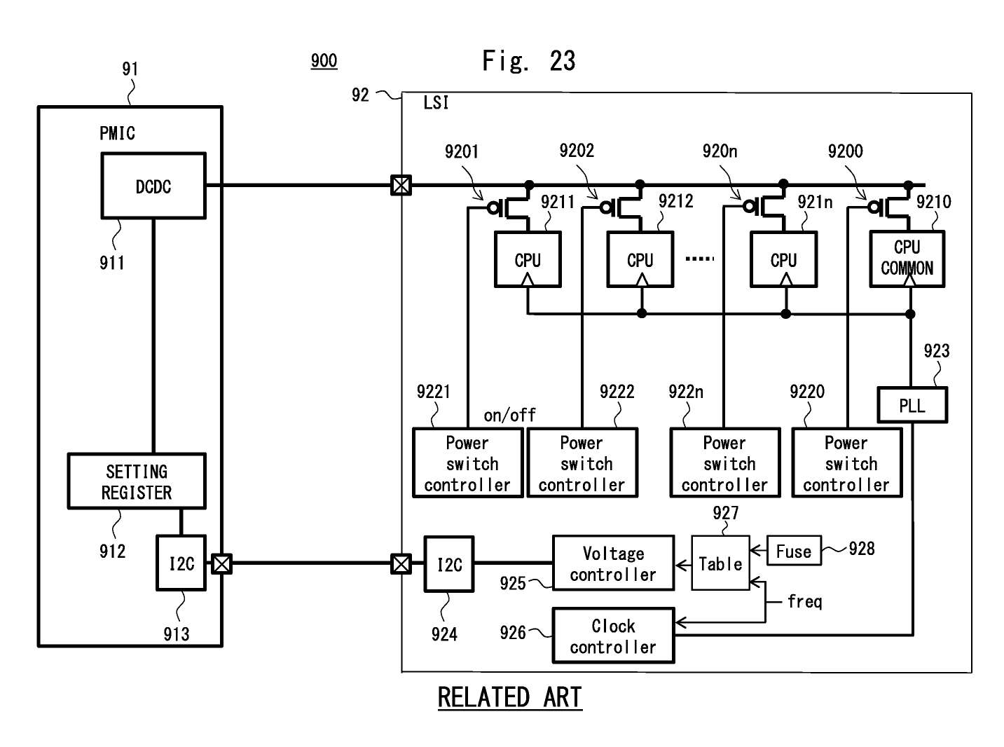

Following is a description of how the inventor has achieved the embodiments. FIG. 23 is a block diagram relating to control of a power supply voltage of a multi-core system 900 according to related art. The multi-core system 900 includes a PMIC (Power Management IC) 91 and an LSI (Large-Scale Integration) 92. The LSI 92 includes a plurality of CPU (Central Processing Unit) cores 9211, 9212, . . . and 921n (n is an integer of two or greater), a CPU common (area) 9210, a plurality of pMOSs (positive Channel Metal Oxide Semiconductors) 9201, 9202, . . . 920n, and 9200, power switch controllers 9221, 9222, . . . 922n, and 9220, a PLL (Phase Locked Loop) 923, an I2C (Inter-Integrated Circuit) 924, a voltage controller 925, a clock controller 926, a table 927, and a fuse 928.

The CPU cores 9211 to 921n and CPU common 9210 can each turn on/off a variable power supply voltage supplied from the PMIC 91 independently by controlling the pMOSs 9201 and the like using the power switching controllers 9221 and the like, respectively. That is, each of the CPU cores 9211 to 921n and CPU common 9210 has a power supply switch, and thus each of the CPU cores 9211 to 921n and CPU common 9210 has a mechanism capable of independently blocking the power supply.

Moreover, the clock controller 926 outputs a clock corresponding to a frequency freq, and the PLL 923 divides a frequency of the clock and supplies frequency-divided clock to the CPU cores 9211 to 921n and CPU common 9210 in common.

The voltage controller 925 generates an instruction for a requested voltage value based on a voltage value selected in the table 927 according to the fuse 928 and frequency freq, and transmits the instruction to the PMIC 91 via the I2C 924.

The PMIC 91 includes a DCDC 911, a setting register 912, and an I2C 913. The PMIC 91 accepts the instruction for the voltage value from the LSI 92 via the I2C 913. The DCDC 911 generates a variable voltage according to a voltage value selected by the setting register 912, and outputs the generated variable voltage to the LSI 92. Therefore, the PMIC 91 can change voltages using techniques such as Dynamic Voltage Frequency Scaling (DVFS) and Adaptive Voltage Scaling (AVS). DVFS is a technique for dynamically changing the power supply voltage according to the frequency freq. AVS is a technique for adaptively adjusting the power supply voltage according to processes and other circumstances. It is assumed that the PMIC 91 and LSI 92 can use communication protocols such as I2C or the like.

However, with the above configuration, it is necessary for the PMIC 91 to be capable of finely adjusting the voltage (e.g., with a resolution of about 10 mV), which raises a problem of increased BOM (Bill Of Material) cost by using a highly functional PMIC. There is another problem that specifying the function and type of the PMIC 91 causes, for example, flexibility that allows a user to again use a PMIC that has been previously used by the user, to be lost. There is still another problem in that a huge bypass capacitor is required in order to consider unintentional load variations in a plurality of CPU cores with a PMIC or the like, which also leads to an increase in the BOM cost. In the case of the multi-core system 900, although it is possible to control on/off of the power supply voltage independently for each CPU core, it is not possible to independently change the voltage value for each CPU core.

Therefore, in order to independently control the power supply voltages of a plurality of CPU cores using an inexpensive PMIC, a large number of switch transistors could be provided in each CPU core to control the power supply voltage. However, in Patent Literature 1 to 3 described above, there is a problem that it is difficult to control a large number of switch transistors at high speed because of analog control.

Thus, embodiments for solving the above-described problem will be described hereinafter.

### First Embodiment

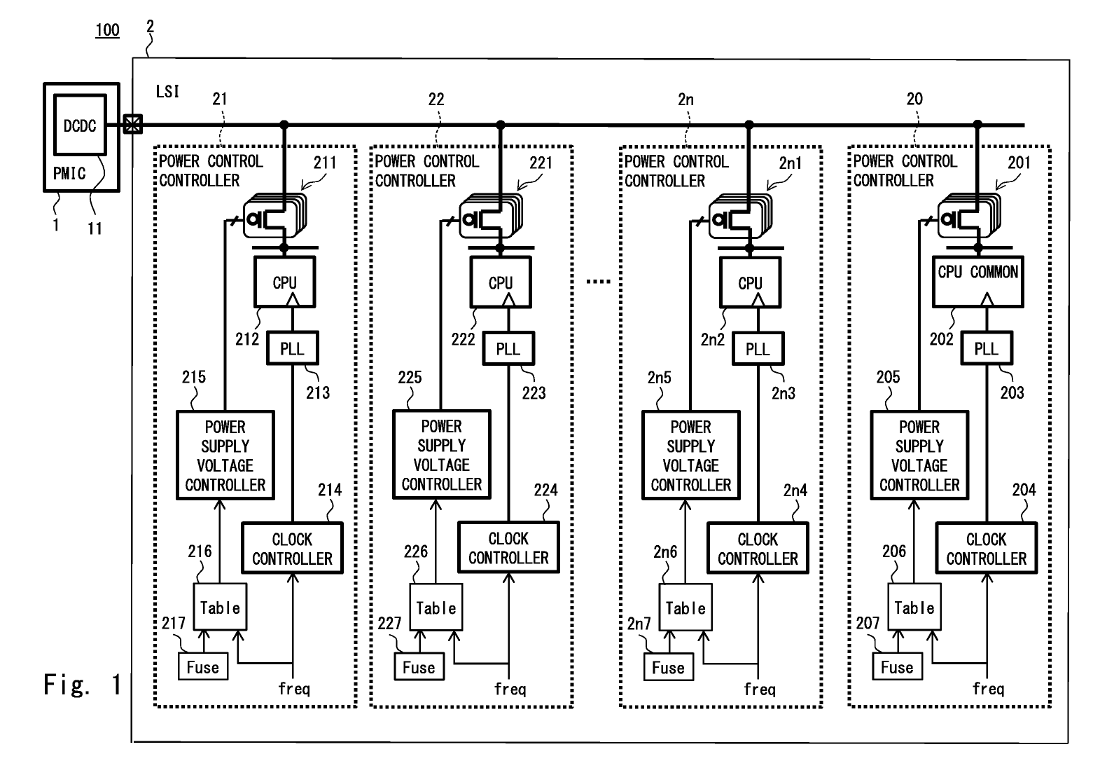

FIG. 1 is a block diagram showing a configuration of a semiconductor system 100 according to a first embodiment. The semiconductor system 100 includes a PMIC 1 and an LSI 2. The PMIC 1 includes at least a DCDC 11. The PMIC 1 may only be a power supply device capable of supplying a fixed voltage to the LSI 2. Therefore, the PMIC 1 can be inexpensive compared to the above-described PMIC 91. Note that the PMIC 1 according to the first embodiment is not limited to this, and one corresponding to the PMIC 91 may be used.

The LSI 2 is an example of a multi-core semiconductor device. The LSI 2 includes power control controllers 21, 22, . . . 2n and 20. The power control controller 21 includes a pMOS group 211, a CPU core 212, a PLL 213, a clock controller 214, a power supply voltage controller 215, a target voltage value setting table 216, and a fuse 217. The power control controllers 22 to 2n have the same configuration as that of the power control controller 21. Further, the power control controller 20 has the same configuration as that of the power control controller 21, except that the CPU core 212 in the power control controller 21 is replaced with a CPU common 202. Therefore, the description of the same configuration will be omitted below. Note that the CPU common 202 is, for example, a secondary cache area or the like shared by the CPU cores.

It can be said that the LSI 2 includes an on-chip voltage step-down mechanism capable of controlling the power supply voltage by DVFS and AVS independently for each CPU core and CPU common area. In order to change the voltage, a frequency freq is changed or a setting value of fuse is used. The LSI 2 functions also as a power supply switch and a power block.

The LSI 2 further includes a register, a system controller, and the like (not shown). In the register, it is assumed that an operation mode and a multiplication rate or division ratio of the PLL and the like are specified for each power control controller. The system controller sets the operation mode in the register. The power supply voltage controller 215 and clock controller 214 refer to the setting value of the register and perform control according to the setting.

In the LSI 2, an OS (Operating System) (not shown) and various software are operating on at least one of the CPUs 212 to 2n2. The OS monitors the frequency freq of each CPU core and controls the frequency freq to be supplied by providing an instruction as appropriate. Specific software running on the OS monitors a load status of the CPU. Then, the specific software updates the multiplication rate, division ratio, or the like specified in the register according to the load status. The PLL 213 adjusts the frequency supplied from the clock controller 214 according to the multiplication rate or division ratio specified in the register, and supplies the adjusted frequency to the CPU 212.

The target voltage value setting table 216 is an example of a storage unit that stores a plurality of target voltage values each associated with a combination of the setting value of the fuse 217 and the clock frequency. The target voltage value setting table 216 identifies the target voltage value associated with the combination of the setting value of the fuse 217 and the clock frequency, which are to be input, and outputs the identified target voltage value to the power supply voltage controller 215.

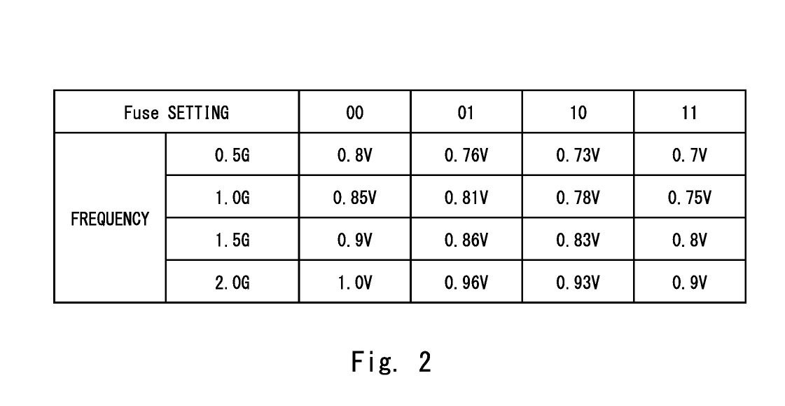

FIG. 2 is a drawing showing an example of the target voltage value setting table 216 according to the first embodiment. In FIG. 2, target voltage values target_VID corresponding to four combinations of the fuse setting value and frequency freq are defined respectively. Note that the types and combinations of the fuse setting values, frequencies freq and target voltage values are not limited to the above. As the fuse setting value varies in speed depending on the process, the setting is changed according to the speed. The fuse setting value may be, for example, tested in advance by a tester. Further, the target voltage values target_VID defined in the target voltage value setting table 216 may be varied, for example, in 10 mV increments. Note that the target voltage value setting table 226 to 2n6 and 206 may have definitions different from that of the target voltage value setting table 216.

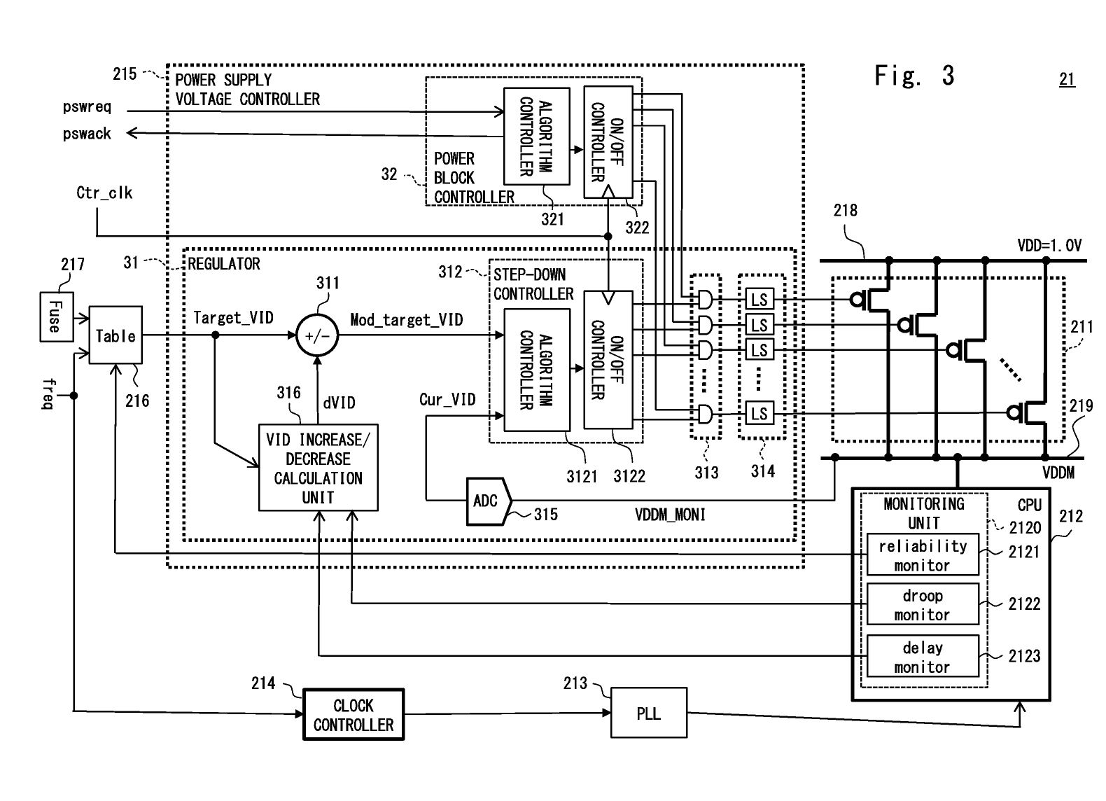

FIG. 3 is a block diagram showing a configuration of the power control controller 21 according to the first embodiment. It can be said that the power control controller 21 is a control circuit serving as both an on-chip step-down circuit and a power supply switch. FIG. 3 shows the configuration of the power control controller 21 in a more specific manner than that shown in FIG. 1. Firstly, a supply voltage line 218 is a power supply voltage line that accepts a supply voltage VDD which is a fixed voltage supplied by the PMIC 1. The supply voltage VDD is, for example, 1.0 V but it is not limited to this. A control voltage line 219 is a power supply voltage line that supplies a control voltage VDDM to the CPU 212. The pMOSs included in the pMOS group 211 are connected in parallel between the supply voltage line 218 and control voltage line 219. Each gate control line included in each pMOS is connected to each level shifter of a level shifter group 314, which will be described later.

The power supply voltage controller 215 includes a regulator 31 and a power block controller 32. The regulator 31 includes an adder/subtracter 311, a step-down controller 312, an AND circuit group 313, the level shifter group 314, an ADC 315, and a VID increase/decrease calculation unit 316. The step-down controller 312 includes an algorithm controller 3121 and an on/off controller 3122.

As described above, the target voltage value target_VID associated with the combination of the setting value of the fuse 217 and frequency freq is selected in the target voltage value setting table 216. Then, the target voltage value setting table 216 outputs the selected target voltage value target_VID to the adder/subtracter 311 and VID increase/decrease calculation unit 316.

The adder/subtracter 311 performs addition or subtraction on the target voltage value target_VID selected in the target voltage value setting table 216 and a differential voltage value dVID received from the VID increase/decrease calculation unit 316, and outputs a modified target voltage value Mod_target VID as a result of the increase/decrease to the algorithm controller 3121.

The algorithm controller 3121 accepts the modified target voltage value Mod_target_VID from the adder/subtracter 311 and a current voltage value Cur_VID from the ADC 315, and derives the number of pMOSs or the positions of pMOSs necessary to bring the current voltage value Cur_VID close to the modified target voltage value Mod_target_VID. Then, the algorithm controller 3121 notifies the on/off controller 3122 of the derived number of pMOSs or the positions of pMOSs. It is assumed that the algorithm controller 3121 uses a control algorithm that brings a combined resistance of the pMOS group 211 close to the modified target voltage value Mod_target_VID. As the control algorithm, for example, PID (Proportional-Integral-Differential) control or the like is used, but it is not limited to this.

The on/off controller 3122 performs control to turn on/off output signal lines corresponding to the number of pMOSs or the positions of pMOSs according to the notification from the algorithm controller 3121.

The power block controller 32 includes an algorithm controller 321 and an on/off controller 322. The algorithm controller 321 derives the number of pMOSs or the positions of pMOSs necessary for transitioning to a Power On mode MD1 (which will be described later) in response to a power supply switch request signal pswreq, and then notifies the on/off controller 322 of the derived number of pMOSs or the positions of pMOSs. Further, in response to reception of the power supply switch request signal pswreq, the algorithm controller 321 outputs a power supply switch acknowledgement signal pswack. The algorithm controller 321 may use an algorithm that turns on all the pMOSs within a predetermined period. However, when the power supply switch request signal pswreq is turned off, the on/off controller 322 is instructed to disable all the pMOSs. Note that the power supply switch request signal pswreq may be specified in the register or the like. The on/off controller 322 performs control to turn on/off the output signal lines corresponding to the number of pMOSs or the positions of pMOS according to the notification from the algorithm controller 321. It is assumed that both the on/off controller 322 of the power block controller 32 and the above-described on/off controller 3122 of the regulator 31 operate in accordance with a control clock Ctr_clk.

The AND circuit group 313 is a set of AND circuits that each perform an AND operation on the output signal line of the on/off controller 3122 and the on/off controller 322 for corresponding pMOS. The level shifter group 314 level-shifts the output signal lines from the respective AND circuits of the AND circuit group 313 and connects them to the gate control lines of the respective pMOSs of the pMOS group 211. That is, the gate control lines of the respective pMOSs are exclusively controlled by the step-down controller 312 and power block controller 32 via the level shifter group 314.

The ADC 315 converts a monitoring voltage VDDM_MONI output from the control voltage line 219 into a digital value and outputs the converted digital value as the current voltage value Cur_VID to the algorithm controller 3121.

The CPU core 212 includes a monitoring unit 2120 and a RAM (not shown) such as a primary cache. The monitoring unit 2120 includes a reliability monitor 2121, a droop monitor 2122, and a delay monitor 2123.

The reliability monitor 2121 monitors age deterioration of the CPU core 212 and, when a predetermined condition is satisfied, outputs a signal for deleting or invalidating some combinations in the target voltage value setting table 216. The droop monitor 2122 is a monitor for detecting a voltage drop caused by rapid load variations in the CPU core 212. The droop monitor 2122 detects a voltage on the sampling side, which is faster than an on/off control frequency of the pMOSs, and makes it in time for the next on/off control. A sampling rate of the droop monitor 2122 is, for example, about 100 ps to 1 ns. Then, the droop monitor 2122 measures a voltage droop and, when a predetermined condition is satisfied, outputs an up signal to the VID increase/decrease calculation unit 316. When a process or temperature satisfies a predetermined condition, the delay monitor 2123 outputs an up or down signal to the VID increase/decrease calculation unit 316.

The VID increase/decrease calculation unit 316 increases or decreases the voltage value based on the target voltage value target_VID selected in the target voltage value setting table 216 and the up or down signal output from the droop monitor 2122 or the delay monitor 2123. Then, the VID increase/decrease calculation unit 316 outputs the increased or decreased voltage value to the adder/subtracter 311 as the differential voltage value dVID.

It can be said that the power control controller 21 has the following three feedback loops as a step-down control function. In the first feedback loop, the ADC 315 digitally converts the control voltage VDDM stepped down by the control of the step-down controller 312 and returns the digitally converted control voltage VDDM as the current voltage value Cur_VID to the step-down controller 312. In the second feedback loop, the differential voltage value dVID is increased or decreased based on the signals from the two types of monitors (droop monitor 2122 and delay monitor 2123) in the CPU core 212 in order to correct the target voltage value target_VID. In the third feedback loop, the target voltage value setting table 216 for determining the target voltage value target_VID is adjusted based on the signal from the reliability monitor 2121.

### <First Feedback Loop>

Firstly, a first feedback loop will be described.

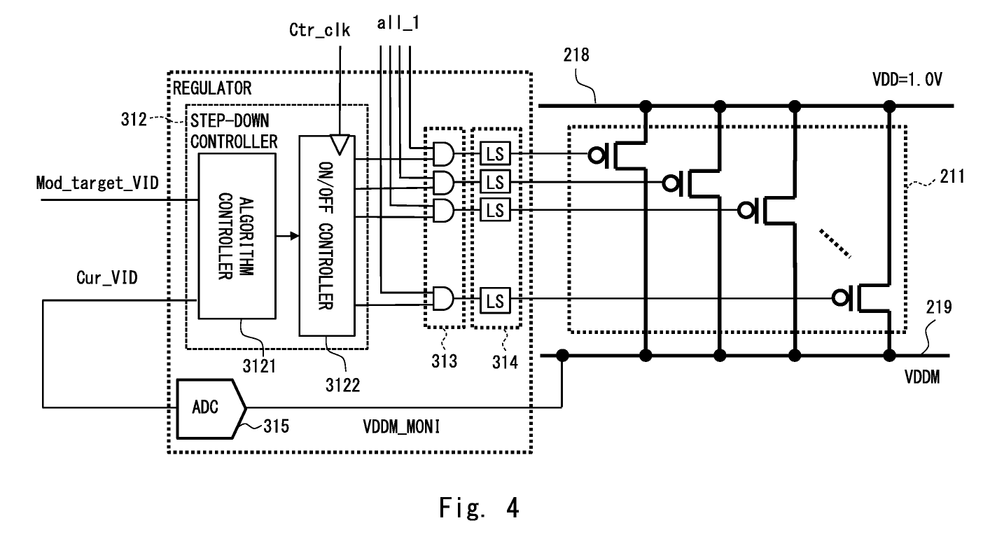

FIG. 4 is a drawing showing a configuration relating to the first feedback loop of the power control controller according to the first embodiment. It is assumed that the control by the power block controller 32 serving as the power supply switch is in the state of Disable, i.e., all the output signal lines are set to 1. In such a state, the step-down controller 312 performs control to turn on/off the output signal lines in order to bring the current voltage value Cur_VID close to the modified target voltage value Mod_target_VID. As described above, the output signal lines from the on/off controller 3122 and output signal lines from the on/off controller 322 are input to the AND circuit group 313. Consequently, control performed by the step-down controller 312 to individually turn on/off the output signal lines will become control to individually turn on/off the gate control lines of the respective pMOSs of the pMOS group 211, thereby stepping down the combined resistance between the supply voltage VDD and control voltage VDDM to a predetermined voltage. In this manner, the control voltage VDDM can be finely adjusted. Note that the number of the gate control lines may be, for example, 64 or 128, but it is not limited to this.

The step-down circuit disclosed in the techniques according to Patent Literature 1 to 3 described above is for controlling the gate voltage by analog control. On the other hand, in this embodiment, the control is digitally performed in an on/off manner, thereby making it possible to respond at a high speed. For example, in the analog control, the responding speed has been about 1 MHz, while in this embodiment, high-speed control at 100 MHz or greater can be achieved. By the high-speed control, it is possible to prevent a sudden drop in the voltage during rapid load variations, and the amount of the drop can be made within a practical range by using only an on-chip capacitance.

### <Second Feedback Loop>

Next, the second feedback loop will be described.

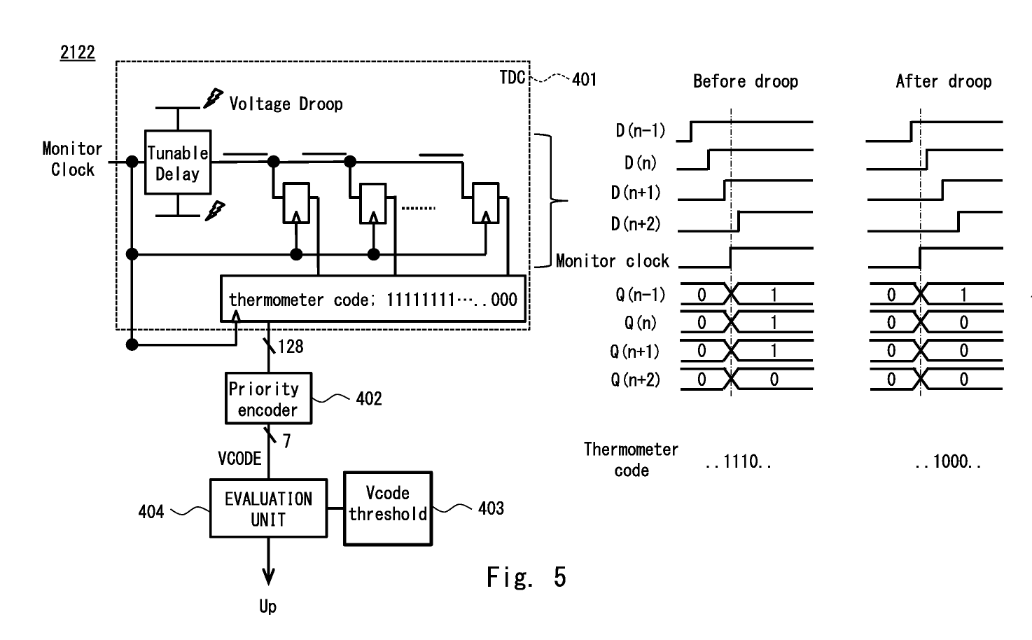

FIG. 5 is a drawing for describing a concept including an example of the droop monitor 2122 according to the first embodiment. The droop monitor 2122 includes a TDC (Time to Digital Converter) 401, a priority encoder 402, a Vcode threshold 403, and an evaluation unit 404. The TDC 401 detects a voltage drop according to a monitoring clock and outputs a thermometer code. Then, the priority encoder 402 generates a voltage code VCODE corresponding to the voltage from the thermometer code. When the voltage code VCODE is lower than the Vcode threshold 403, the evaluation unit 404 outputs the up signal.

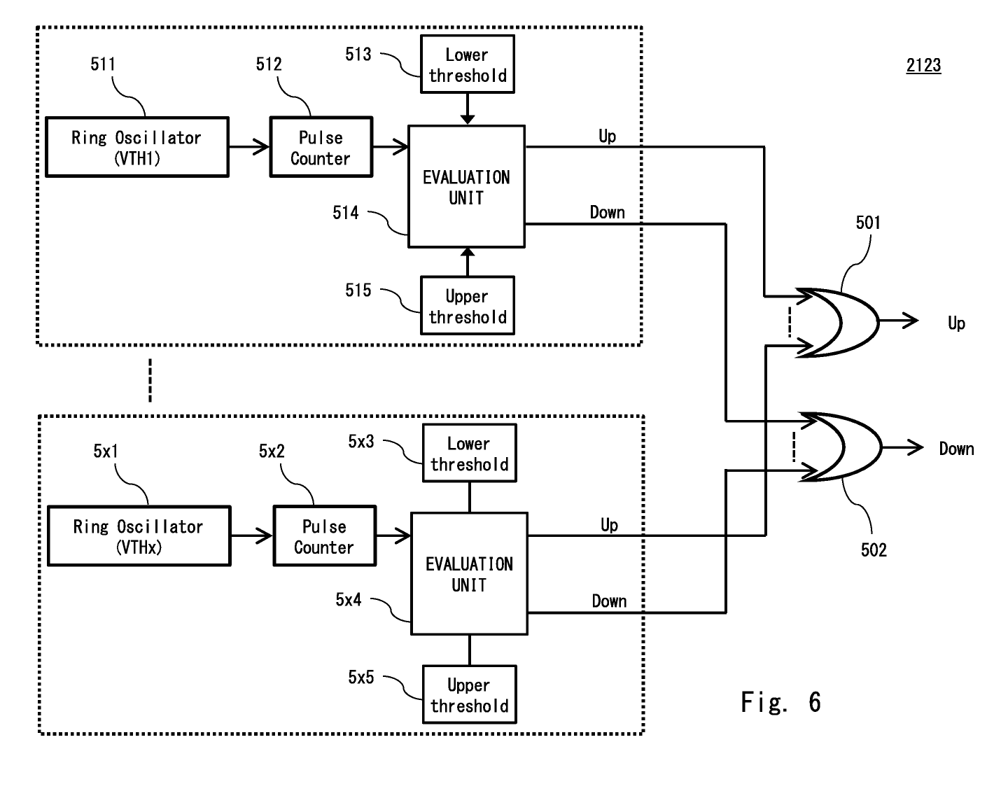

FIG. 6 is a drawing showing an example of the delay monitor 2123 according to the first embodiment. The delay monitor 2123 includes OR circuits 501 and 502, a ring oscillator 511, a pulse counter 512, a lower threshold 513, an evaluation unit 514, an upper threshold 515, . . . a ring oscillator 5x1, a pulse counter 5x2, a lower threshold 5x3, an evaluation unit 5x4, and an upper threshold 5x5. Note that x is an integer of two or greater and indicates the type of transistor in the CPU core 212. That is, the ring oscillators 511 to 5x1 correspond to threshold voltages of different transistors, respectively. The pulse counter 512 measures a frequency oscillated by the ring oscillator 511. The evaluation unit 514 evaluates as to whether or not the frequency measured by the pulse counter 512 falls below the lower threshold 513 or exceeds the upper threshold 515, and outputs an up signal or down signal according to a result of the evaluation. The ring oscillator 5x1, pulse counter 5x2, lower threshold 5x3, evaluation unit 5x4, upper threshold 5x5, and the like operate in the same way as the corresponding components described above. Thus the description for these components will be omitted. The OR circuit 501 outputs a result of an OR operation of the up signals output from respective evaluation units as an up signal. The OR circuit 502 outputs a result of an OR operation of the down signals output from respective evaluation units as a down signal. Note that the delay monitor 2123 updates values between, for example, 1 us (microseconds) and 100 us.

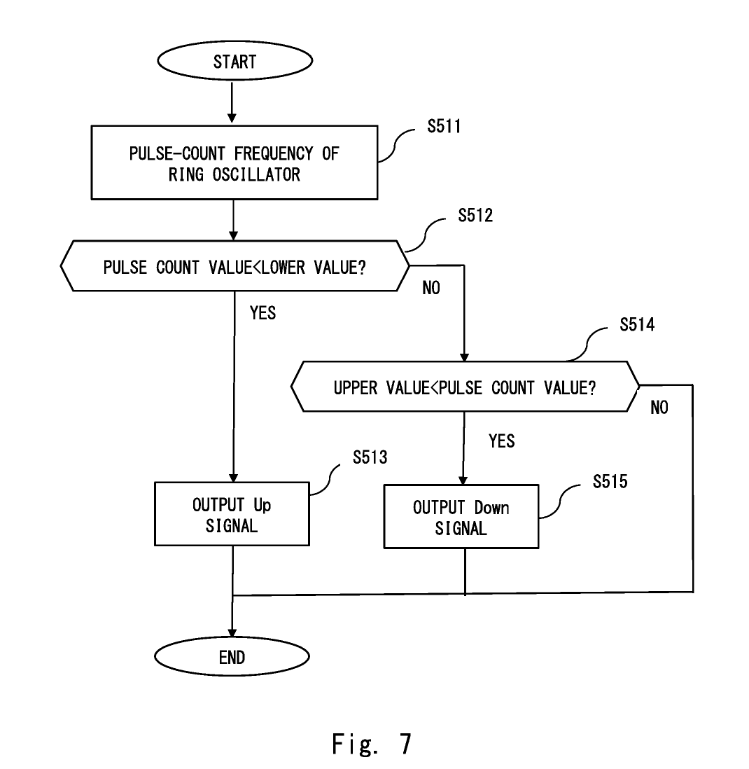

FIG. 7 is a flowchart for describing a flow of a process of the delay monitor 2123 according to the first embodiment. Firstly, the pulse counter 512 pulse-counts the frequency of the ring oscillator 511 (S511). Next, the evaluation unit 514 evaluates as to whether or not a pulse count value is lower than the lower threshold 513 (S512). When the pulse count value is lower than the lower threshold 513, the evaluation unit 514 turns on the up signal, and the OR circuit 501 outputs the up signal to the VID increase/decrease calculation unit 316 (S513). On the other hand, when the pulse count value is the lower threshold 513 or greater in S512, the evaluation unit 514 evaluates as to whether or not the pulse count value is greater than the upper threshold 515 (S514). When the pulse count value is greater than the upper threshold 515, the evaluation unit 514 turns on the down signal, and the OR circuit 502 outputs the down signal to the VID increase/decrease calculation unit 316 (S515).

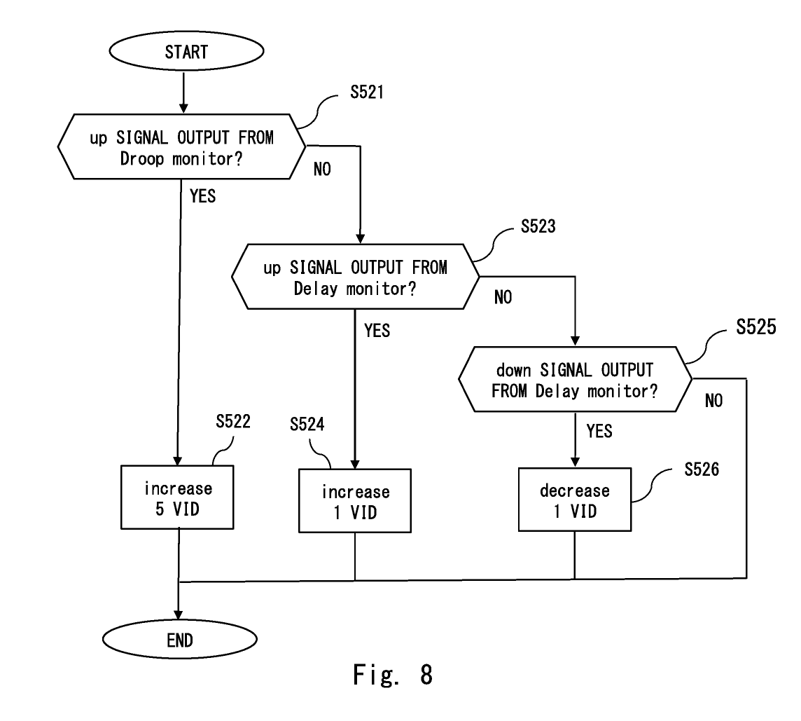

FIG. 8 is a flowchart for describing a flow of a process of the second feedback loop according to the first embodiment. Firstly, the VID increase/decrease calculation unit 316 evaluates as to whether or not the up signal is output from the droop monitor 2122 (S521). If the up signal is turned on, the VID increase/decrease calculation unit 316 increases the VID by, for example, 5 (S522). On the other hand, if the up signal is turned off, the VID increase/decrease calculation unit 316 evaluates as to whether or not the up signal is output from the delay monitor 2123 (S523). If the up signal is turned on, the VID increase/decrease calculation unit 316 increases the VID by, for example, 1 (S524). On the other hand, if the up signal is turned off, the VID increase/decrease calculation unit 316 evaluates as to whether or not the down signal is output from the delay monitor 2123 (S525). If the down signal is turned on, the VID increase/decrease calculation unit 316 decreases the VID by, for example, 1 (S526).

Note that in the above description, the 1 VID is assumed to be 10 mV, but it is not limited to this. The values of the increase/decrease for the VID are merely examples. However, it is assumed that the added value of Step S522 is greater than that in Step S524.

As described above, when the droop monitor 2122 detects sudden load variations in the CPU core 212, the VID increase/decrease calculation unit 316 increases the voltage so that the CPU core 212 does not run away. On the other hand, when a droop is not occurring, the delay monitor 2123 functions. The delay monitor 2123 generates the up or down signal in order to satisfy a delay time necessary for a delay that varies according to a process, temperature, and voltage. When the VID increase/decrease calculation unit 316 detects the up or down signal from the delay monitor 2123, it reduces the amount of the increase and decrease as compared with the case when it detects the up signal from the droop monitor 2122. By adjusting the delay so that it falls between the lower value and upper value, it is possible to step down the voltage to an appropriate voltage value in real time.

### <Third Feedback Loop>

Next, a third feedback loop will be described.

The reliability monitor 2121 monitors the age deterioration of the CPU core 212 such as NBTI (Negative Bias Temperature Instability (BTI), PBTI (Positive BTI), HCI (Hot Carrier Injection), and the like. When the deterioration progresses, the column of the target voltage value setting table 216 corresponding to the highest frequency in the table is prohibited from being used. By doing so, it is possible to operate with an appropriate frequency and voltage even when the CPU deteriorates over time.

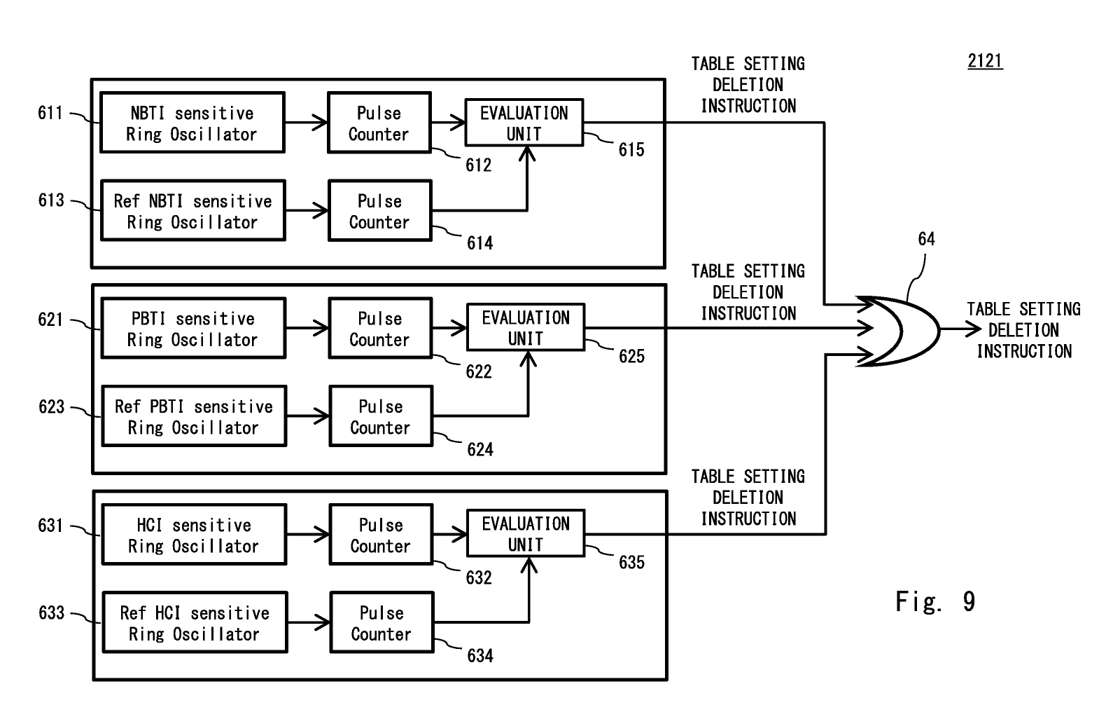

FIG. 9 is a drawing showing an example of the reliability monitor 2121 according to the first embodiment. The reliability monitor 2121 includes an NBTI sensitivity ring oscillator 611, a pulse counter 612, a reference NBTI sensitivity ring oscillator 613, a pulse counter 614, an evaluation unit 615, a PBTI sensitivity ring oscillator 621, a pulse counter 622, a reference PBTI sensitivity ring oscillator 623, a pulse counter 624, an evaluation unit 625, an HCI sensitivity ring oscillator 631, a pulse counter 632, a reference HCI sensitivity ring oscillator 633, a pulse counter 634, an evaluation unit 635, and an OR circuit 64.

The NBTI sensitivity ring oscillator 611 and reference NBTI sensitivity ring oscillator 613 are ring oscillators with high NBTI sensitivity and have the same configuration. The NBTI sensitivity ring oscillator 611 operates for each clock signal. On the other hand, the reference NBTI sensitivity ring oscillator 613 is powered on only when it performs measurement. For example, the reference NBTI sensitivity ring oscillator 613 is periodically powered on at intervals (100 ms, 1 second, etc.) longer than the clock frequency by means of a timer, a power switch, or the like. That is, a voltage is not normally applied to the reference NBTI sensitivity ring oscillator 613 in order to prevent the deterioration, and the reference NBTI sensitivity ring oscillator 613 oscillates a frequency only when it performs an evaluation.

The pulse counter 612 measures the frequency oscillated by the NBTI sensitivity ring oscillator 611. The pulse counter 614 measures the frequency oscillated by the reference NBTI sensitivity ring oscillator 613. The evaluation unit 615 compares the result of the measurement of the pulse counter 612 with that of the measurement of the pulse counter 614. If the frequency oscillated by the NBTI sensitivity ring oscillator 611 is lower than the frequency oscillated by the reference NBTI sensitivity ring oscillator 613 by a predetermined ratio, the evaluation unit 615 outputs an instruction (table setting deletion instruction) for deleting the setting of the target voltage value corresponding to the highest frequency in the target voltage value setting table 216.

Note that the PBTI sensitivity ring oscillator 621 and reference PBTI sensitivity ring oscillator 623 are ring oscillators with high PBTI sensitivity and have the same configuration. Further, the HCI sensitivity ring oscillator 631 and reference HCI sensitivity ring oscillator 633 are ring oscillators with high HCI sensitivity and have the same configuration. Other configurations are the same as those in the case of NBTI. Thus the descriptions for the cases of PBTI and HCI will be omitted.

When the table setting deletion instruction is output from any one of the evaluation units 615, 625, and 635, the OR circuit 64 outputs the table setting deletion instruction to the target voltage value setting table 216.

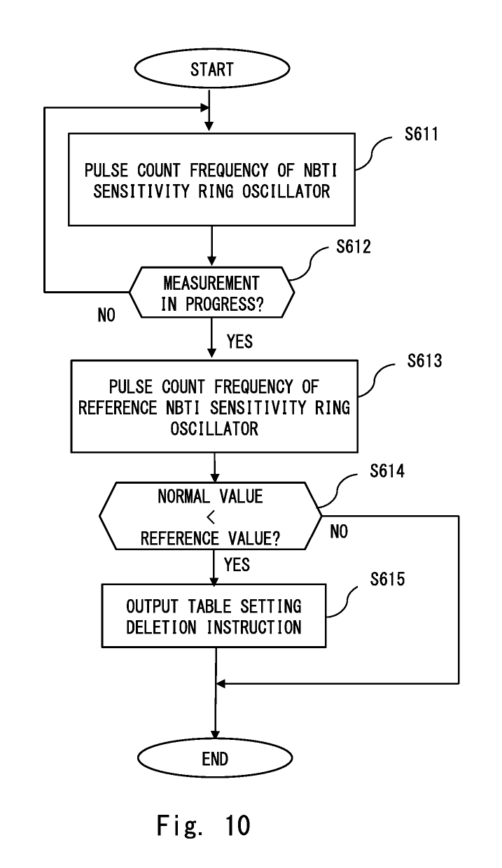

FIG. 10 is a flowchart for describing a flow of a process of the reliability monitor 2121 according to the first embodiment. In this example, the case of NBTI is shown as a representative case, but flows of processes in the cases of PBTI and HCI will be similar to that in the case of NBTI.

Firstly, the pulse counter 612 pulse-counts the frequency of the NBTI sensitivity ring oscillator 611 (S611). Next, the reliability monitor 2121 evaluates as to whether or not the measurement is in progress (S612). For example, as described above, it is evaluated as to whether or not it is an interval longer than the predetermined clock frequency. If the measurement is not in progress, execution of S611 is continued. If the measurement is in progress, the reference NBTI sensitivity ring oscillator 613 is powered on, and the pulse counter 614 pulse-counts the frequency of the reference NBTI sensitivity ring oscillator 613 (S613). Then, the evaluation unit 615 evaluates as to whether or not a normal value that is a result of the measurement by the pulse counter 612 is lower than a reference value that is a result of the measurement by the pulse counter 614 (S614). If the normal value is lower than the reference value, the evaluation unit 615 outputs the table setting deletion instruction (S615).

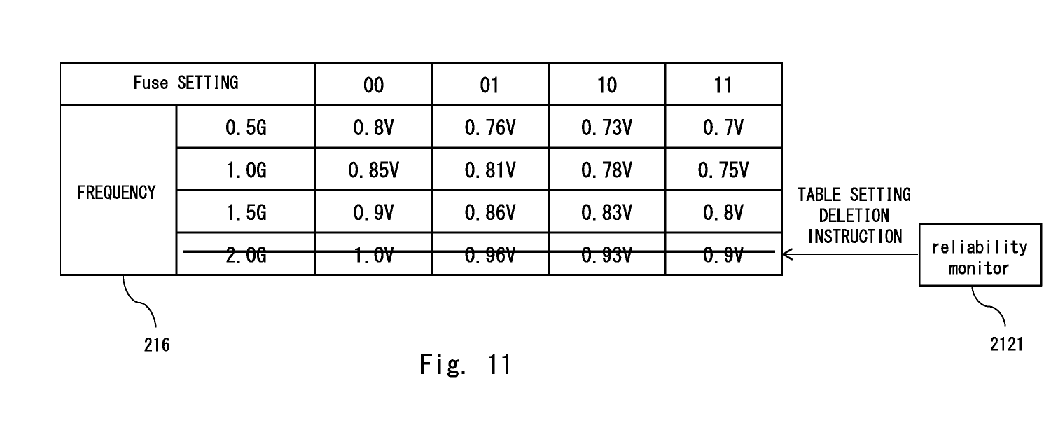

FIG. 11 is a drawing for describing a concept of a process of the third feedback loop according to the first embodiment. In FIG. 11, as the highest frequency in the target voltage value setting table 216 is 2.0 GHz, it indicates that the setting of the target voltage value associated with 2.0 GHz is deleted.

From the above description, the following can be said about the feedback loops in the power control controller 21 according to this embodiment. The high-speed on/off control by the first feedback loop makes it possible to follow the load variations only by the on-chip capacitance. Further, by the second feedback loop, it is possible to apply an appropriate voltage according to the circumstances, thereby preventing unnecessary power consumption. Furthermore, by the third feedback loop, it is possible to use an appropriate operating frequency and apply an appropriate voltage in consideration of the age deterioration.

### <Operation Mode>

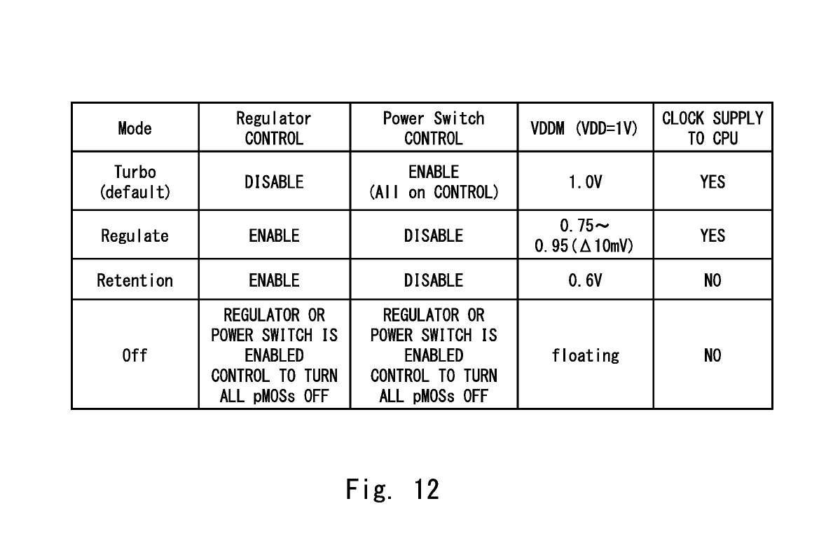

FIG. 12 is a drawing showing an example of the operation modes according to the first embodiment. A Turbo mode MD2 is a default mode. The Turbo mode MD2 functions (Enabled) as a power switch, and a step-down function is Disabled in the Turbo mode MD2. A Regulate mode MD3 is used as a normal operation mode. The Regulate mode MD3 is Disabled as a power switch, and the step-down function is Enabled. A Retention mode MD4 is an operation mode for holding values with low power consumption. An Off mode MD5 is a power block mode. In the Off mode MD5, all the pMOSs are turned off by power switch control to thereby reduce the power consumption.

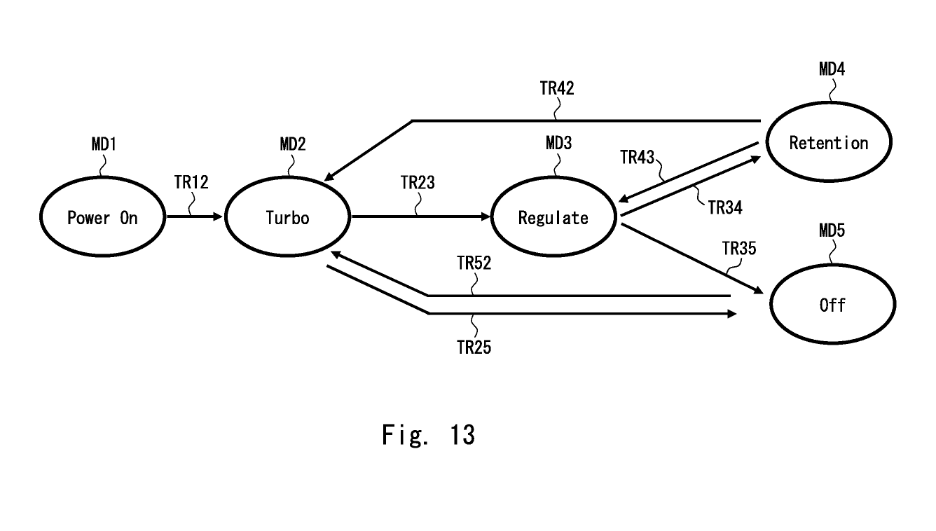

FIG. 13 is a drawing showing an example of transitions of the operation modes according to the first embodiment. Firstly, when the power control controller 21 is powered on, it will be in the Power On mode MD1. Further, supply of a clock to the CPU core 212 is started. At this time, the on/off controller 322 of the power block controller 32 sets all output lines to Enable (0) at once or in a plurality of times, and the on/off controller 3122 of the regulator 31 sets all the output lines to Disable (1). Then, the gate control lines of all the pMOSs are turned on (0, conductive), the control voltage VDDM becomes 1.0 V, and the mode transitions to the Turbo mode MD2 (transition TR12).

Next, a transition from the Turbo mode MD2 to the Regulate mode MD3 (transition TR23) is described. The on/off controller 322 of the power block controller 32 sets all the output lines to Disable (1), and the on/off controller 3122 of the regulator 31 sets some of the output lines to Enable (0). Note that the some of the output lines are the output lines of which the on/off controller 3122 has been notified by the algorithm controller 3121. Therefore, the control voltage VDDM is controlled at a voltage slightly lower than the supply voltage VDD. For example, the voltage can be adjusted in 10 mV increments within a range of 0.75 V and 0.95 V. The voltage values and the adjustment range are merely examples. Then the power control controller can be used as a function of the DVFS and AVS.

Next, a transition from the Regulate mode MD3 to the Retention mode MD4 (transition TR34) is described. In this case, the control of the regulator 31 and power block controller 32 is the same as that in the Regulate mode MD3. However, as the supply of the clock to the CPU core 212 is stopped, consequently the control voltage VDDM is held at, for example, about 0.6 V by the step-down function.

Next, a transition from the Retention mode MD4 to the Turbo mode MD2 (transition TR42) is described. In this case, the supply of the clock to the CPU core 212 is restarted, the on/off controller 322 of the power block controller 32 sets all the output lines to Enable (0), and the on/off controller 3122 of the regulator 31 sets all the output lines to Disable (1).

Next, a transition from the Retention mode MD4 to the Regulate mode MD3 (transition TR43) is described. In this case, the supply of the clock to the CPU core 212 is restarted. Further, the control of the regulator 31 and power block controller 32 is the same as that in the transition TR34.

Next, a transition from the Turbo mode MD2 to the Off mode MD5 (transition TR25) is described. As the on/off controller 322 of the power block controller 32 has already set all the output lines to Disable (1), the on/off controller 3122 of the regulator 31 sets all the output lines to Disable (1). Moreover, the supply of the clock to the CPU core 212 is stopped.

Next, a transition from the Regulate mode MD3 to the Off mode MD5 (transition TR35) is described. As the on/off controller 3122 of the regulator 31 has already set all the output lines to Disable (1), the on/off controller 322 of the power block controller 32 sets all the output lines to Disable (1). Moreover, the supply of the clock to the CPU core 212 is stopped.

Next, a transition from the Off mode MD5 to the Turbo mode MD2 (transition TR52) is described. The supply of the clock to the CPU core 212 is restarted, the on/off controller 322 of the power block controller 32 sets all the output lines to Enable (0), and the on/off controller 3122 of the regulator 31 sets all the output lines to Disable (1).

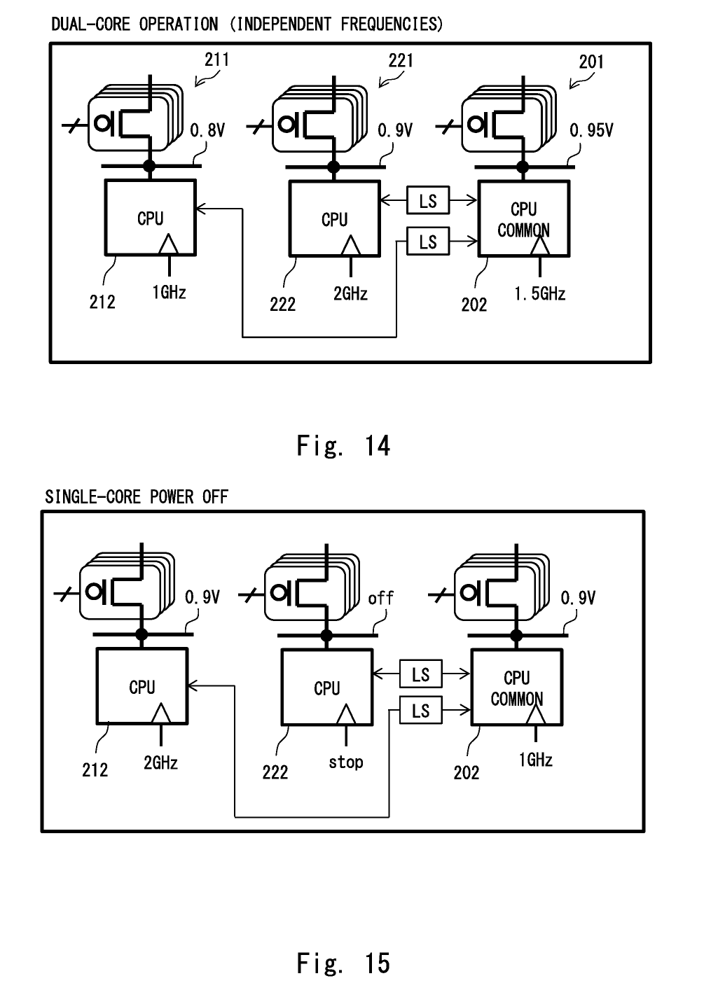

Hereinafter, a case where a plurality of processor cores and the like according to the first embodiment operate in different operation modes will be described. FIG. 14 is a drawing for describing a concept of a dual-core operation according to the first embodiment. In FIG. 14, the CPU cores 212 and 222 and the CPU common 202 are each operating in the Regulate mode MD3. It indicates that the CPU cores 212 and 222 and CPU common 202 are controlled independently with different power supply voltages and clock frequencies.

FIG. 15 is a drawing for describing a concept of single-core power off according to the first embodiment. In FIG. 15, the CPU core 212 and CPU common 202 are operating in the Regulate mode MD3. On the other hand, it indicates that the CPU core 222 is in the Off mode MD5, i.e., the power supply voltage is turned off, and the clock frequency is stopped.

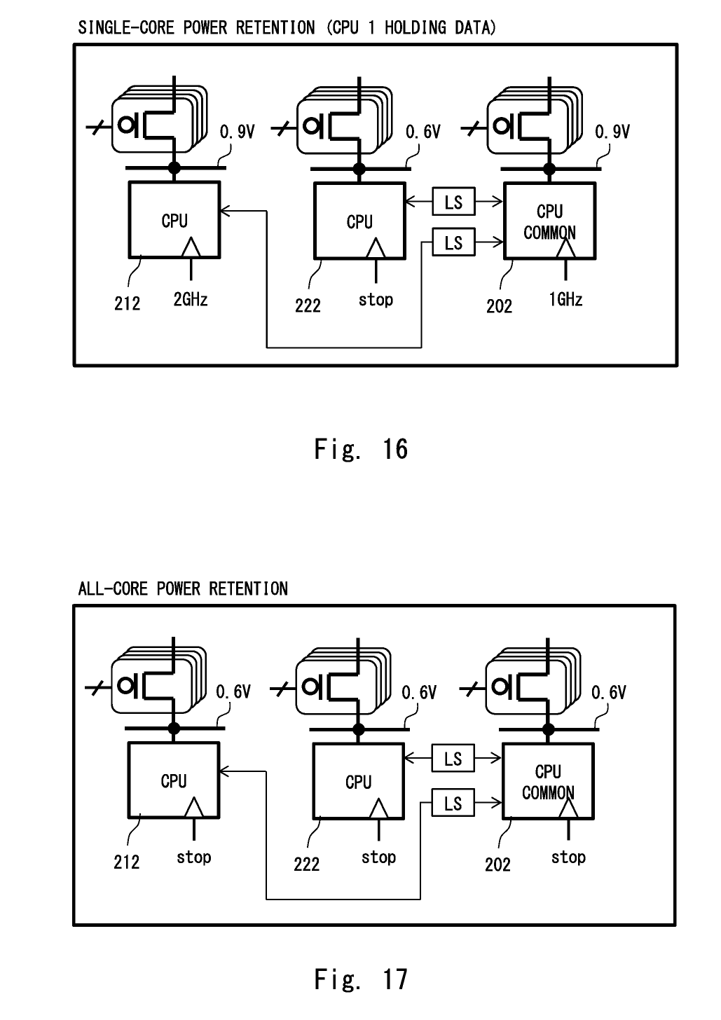

FIG. 16 is a drawing for describing a concept of single-core power retention according to the first embodiment. In FIG. 16, the CPU core 212 and CPU common 202 are operating in the Regulate mode MD3. On the other hand, the CPU core 222 is operating in the Retention mode MD4. That is, in the CPU core 222, although the clock frequency is stopped, the power supply voltage of the CPU core 222 is held as low as 0.6 V, which means that data is held.

FIG. 17 is a drawing for describing a concept of all-core power retention according to the first embodiment. In FIG. 17, the CPU cores 212 and 222 and CPU common 202 are in the Retention mode MD4. Thus, in each of the CPU cores 212 and 222 and CPU common 202, although the clock frequency is stopped, the power supply voltage of the CPU core 222 is held as low as 0.6 V, which means that data is held.

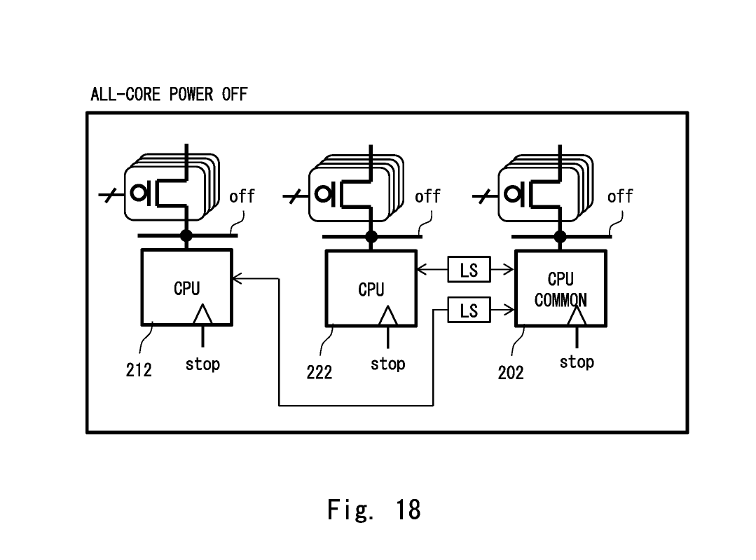

FIG. 18 is a drawing for describing a concept of all-core power off according to the first embodiment. In FIG. 18, it indicates that each of the CPU cores 212 and 222 and CPU common 202 is in the Off mode MD5, i.e., the power supply voltage is turned off, and the clock frequency is stopped.

As described above, according to this embodiment, the power supply voltage can be finely controlled for each CPU core and CPU common area, thereby reducing the power consumption of the entire LSI.

The following can be said about this embodiment. Firstly, this embodiment makes it possible to perform voltage control by DVFS and AVS for each CPU core, which has heretofore been difficult. Thus the power can be reduced. Moreover, as the voltage supplied from the outside is a fixed voltage, a function for changing a power supply voltage provided in the PMIC can be removed. Thus the cost of the PMIC can be reduced. Further, as the load variations in the CPU cores and common area are absorbed by the on-chip step-down circuit, the number of bypass capacitors can be reduced more than in a LSI of related art. In addition, an area cost equivalent to one according to related art can be realized by the step-down circuit that can be shared by the power switch and the driver.

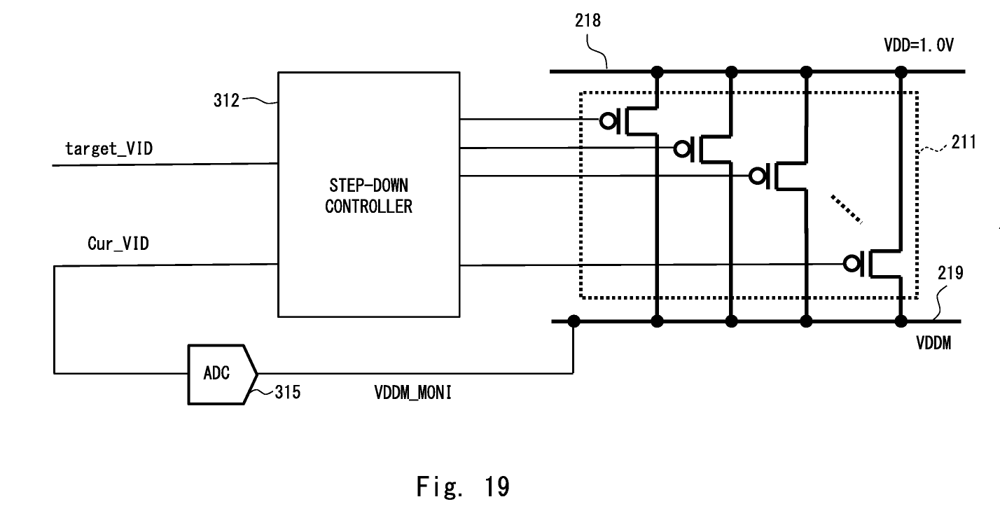

Note that this embodiment may have at least the following configuration. FIG. 19 is a block diagram showing another configuration of a power control controller 70 according to the first embodiment. The power control controller 70 includes a plurality of switch transistors 71, an AD converter 72, and a step-down controller 73. The plurality of switch transistors 71 are a set of switch transistors connected in parallel between a supply voltage line 74 and a control voltage line 75. The AD converter 72 is an analog-to-digital conversion circuit that converts the control voltage VDDM output from the control voltage line 75 into the current voltage value Cur_VID, which is a digital value. The step-down controller 73 is a step-down circuit that controls the plurality of switch transistors 71 in order to bring the converted current voltage value Cur_VID close to the target voltage value target_VID.

In related art, the gate voltages of the switch transistors have been adjusted by analog control. However, in such a case, there is a limitation in high-speed and fine voltage control. In this embodiment, high-speed and fine voltage control can be achieved by digitally turning on and off the gate voltages of a large number of switch transistors, and by controlling the step-down voltage with the combined resistance of the switch transistors.

Further, by controlling a large number of switch transistors in parallel and at high speed to thereby enable fine voltage adjustment for each processor core (and the common area of the processor), and thus the power consumption can be reduced. Furthermore, as it is possible to operate with a fixed voltage that is supplied from the outside, a power supply device does not need a function for changing the power supply voltage. Thus, inexpensive PMIC or a PMIC that has been used by a user can be used. This contributes to reducing the cost of the PMIC.

It is desirable that this embodiment further has the following configuration. That is, the power control controller according to the first embodiment further includes: a monitoring unit configured to monitor an operation state of a processor core; and a target voltage controller configured to output the target voltage value to the step-down controller. When the operation state satisfies a predetermined condition, the monitoring unit outputs an instruction for increasing or decreasing the target voltage value to the target voltage controller, and the target voltage controller controls the increase or decrease of the target voltage value according to the instruction for the increase or the decrease and outputs the increased or decreased target voltage value to the step-down controller. This enables the voltage value to be appropriately adjusted according to the state of the processor core.

Further, it is desirable that the monitoring unit includes a first monitor that, when a temperature of the processor core falls below a predetermined value, outputs a first instruction for increasing the target voltage value to the target voltage controller as the instruction for the increase or the decrease. This enables the voltage value to be appropriately controlled corresponding to sudden load variations.

Furthermore, it is desirable that the monitoring unit includes a second monitor that, when a delay of each transistor inside the processor core exceeds a predetermined range, outputs a second instruction for increasing or decreasing the target voltage value to the target voltage controller as the instruction for the increase or the decrease. This enables a delay to be reduced within a predetermined range.

Moreover, it is desirable that the second monitor is configured to output the second instruction when the first instruction is not output by the first monitor, and a value of the increase or the decrease for the target voltage value in the second instruction is greater than that in the first instruction. This enables fine voltage control because a voltage is greatly increased in response to rapid load variations, and because the voltage can be finely adjusted according to a delay when the load variations are small.

This embodiment may include the following configuration. The power control controller according to the first embodiment further includes a storage unit configured to store a plurality of target voltage values each associated with a combination of a fuse setting value and a clock frequency. The target voltage controller selects the target voltage value associated with the combination of the input fuse setting value and the input clock frequency among the plurality of target voltage values, controls the increase or the decrease of the selected target voltage value according to the instruction for the increase or the decrease, and outputs the increased or decreased target voltage value to the step-down controller. This enables appropriate adjustment of a voltage value according to variations in speed caused by processes or the like.

Moreover, the monitoring unit includes a third monitor that outputs a third instruction for excluding, from the selection, the target voltage value associated with the combination of a higher one of the clock frequency from among the combinations according to a state of deterioration of the processor core to the storage unit, and the target voltage controller may select the target voltage value associated with the combination of the input fuse setting value and the input clock frequency from among the target voltage values excluding the target voltage value excluded from the selection from among the plurality of target voltage values. Thus, by preventing a high frequency from being used in the case of age deterioration, it is possible to adjust a voltage value to an appropriate voltage value.

Further, it is desirable that the power control controller according to the first embodiment further includes a power block controller that performs an AND operation on output of the step-down controller and controls to turn on/off for each of the plurality of switch transistors. As the power control controller serving both as a power supply switch and a regulator, a circuit size can be reduced.

Note that the semiconductor device according to the first embodiment can be expressed as follows. That is, a semiconductor device includes a plurality of power control controllers. Each of the plurality of power control controller includes: a processor core; a plurality of switch transistors connected in parallel between a supply voltage line and a control voltage line, the control voltage line supplying a power supply voltage to the processor core; an AD converter configured to convert a control voltage output from the control voltage line into a current voltage value, the current voltage value being a digital value; a storage unit configured to store a plurality of target voltage values each associated with a combination of a fuse setting value and a clock frequency; and a step-down controller configured to control the plurality of switch transistors in order to bring the converted current voltage value close to a target voltage value selected from among the plurality of target voltage values, wherein a plurality of the storage units included respectively in the plurality of power control controller have different specified values from one another.

The semiconductor system according to the first embodiment can be expressed as follows. That is, the semiconductor system includes a semiconductor device and a power supply device. The semiconductor device includes a plurality of power control controllers. Each of the plurality of power control controller includes: a processor core; a plurality of switch transistors connected in parallel between a supply voltage line and a control voltage line, the control voltage line supplying a power supply voltage to the processor core; an AD converter configured to convert a control voltage output from the control voltage line into a current voltage value, the current voltage value being a digital value; and a step-down controller configured to control the plurality of switch transistors in order to bring the converted current voltage value close to a target voltage value. The power supply device is configured to supply a fixed voltage to the supply voltage line.

### Second Embodiment

In a second embodiment, an application example of the above-described first embodiment is described. In the second embodiment, a technique for reducing an inrush current, i.e., large current flowing due to the charge accumulated up to then, when the power is turned on will be described.

That is, a step-down controller according to the second embodiment performs control so that all switch transistors are turned on when the power control controller is powered on, and the power block controller performs control so that the plurality of switch transistors are turned on in a plurality of times. In this manner, it is possible to reduce the inrush current at the time of returning from power block.

It is desirable that control be performed so that when the power control controller is powered on, the power supply block controller turns on some of the plurality of switch transistors in a plurality of times, and then collectively turns on the remaining switch transistors. By doing so, it is possible to reduce the inrush current and enables early return.

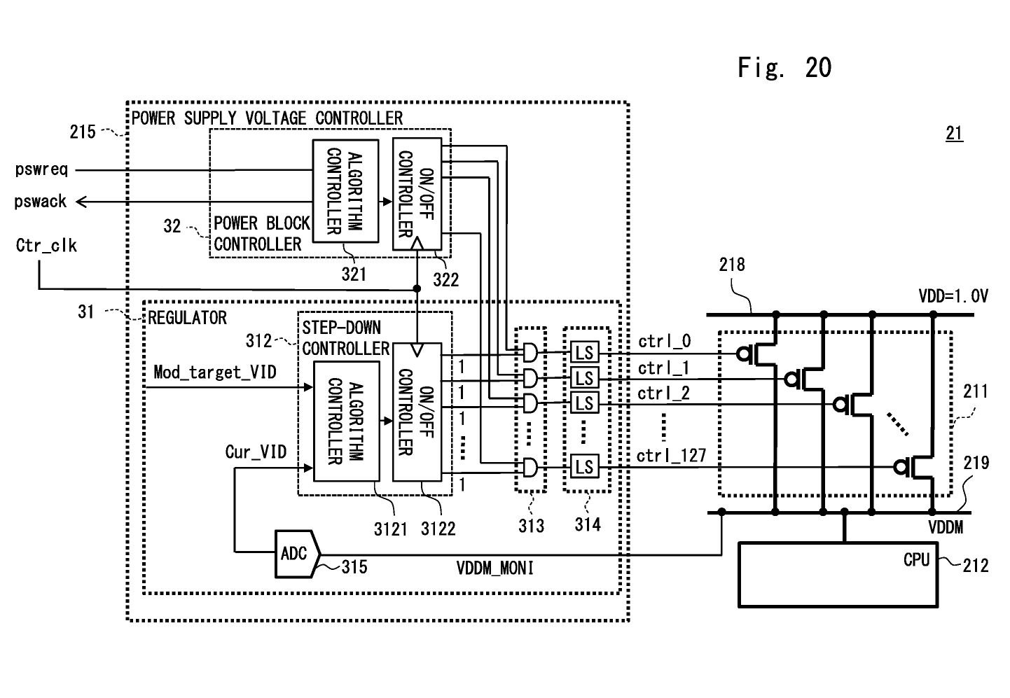

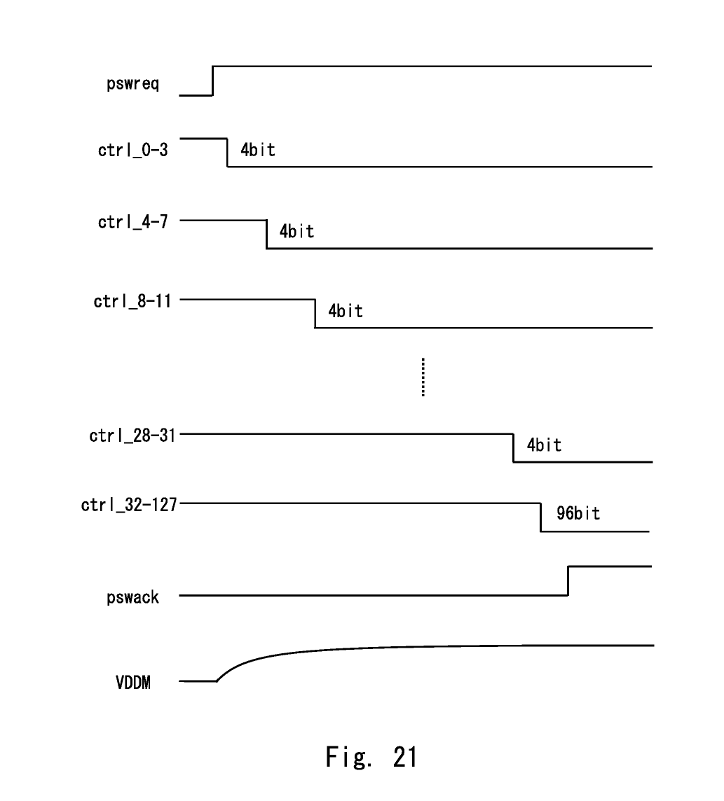

FIG. 20 is a drawing showing a configuration relating to a process when a power switch of a power control controller according to a second embodiment is turned on. Firstly, it is assumed that the number of gate control lines ctrl_0 to ctrl_127 of each pMOS in the pMOS group 211 is 128. In the case of the above-described transition TR12, the on/off controller 3122 of the regulator 31 sets all the output lines to Disable (1). On the other hand, the on/off controller 322 of the power block control unit 32 according to the second embodiment switches the output signal lines from 1 to 0 in 8 steps of 4 bits at a time. As a result, the gate control lines ctrl_0 to ctrl_31 are turned on (0, conductive) in steps, and the control voltage VDDM gently rises. After that, the on/off controller 322 collectively switches the remaining the output signal lines from 1 to 0. Thus, all the gate control lines ctrl_32 to ctrl_128 are turned on (0, conductive), the control voltage VDDM becomes 1.0 V, and the mode transitions to the Turbo mode MD2. FIG. 21 is a drawing showing examples of respective signals when the power switch is turned on according to the second embodiment.

As described above, according to the second embodiment, it is possible to reduce the inrush current at the time of returning from the power block. Moreover, it is possible to achieve both the power switch control and the step-down control for reducing the inrush current without increasing the circuit area.

### Third Embodiment

In a third embodiment, a modified example of the above embodiment is described. Commonly, in an RAM area such as a primary cache or the like in each CPU core, it is more difficult to lower the power supply voltage as compared with those supplied to other components in the CPU core. Therefore, in the third embodiment, a power supply voltage different from those supplied to other components in the processor core is supplied to the storage area in the processor core. Alternatively, the power supply voltage to the storage area in the processor core is controlled independently from those supplied to other components in the processor core. By doing so, it is possible to stabilize the power supply by supplying a fixed voltage to the primary cache area and the like while performing efficient control on the other components in the processor core using variable voltages. Note that the primary cache area and the like may also be controlled by a variable voltage.

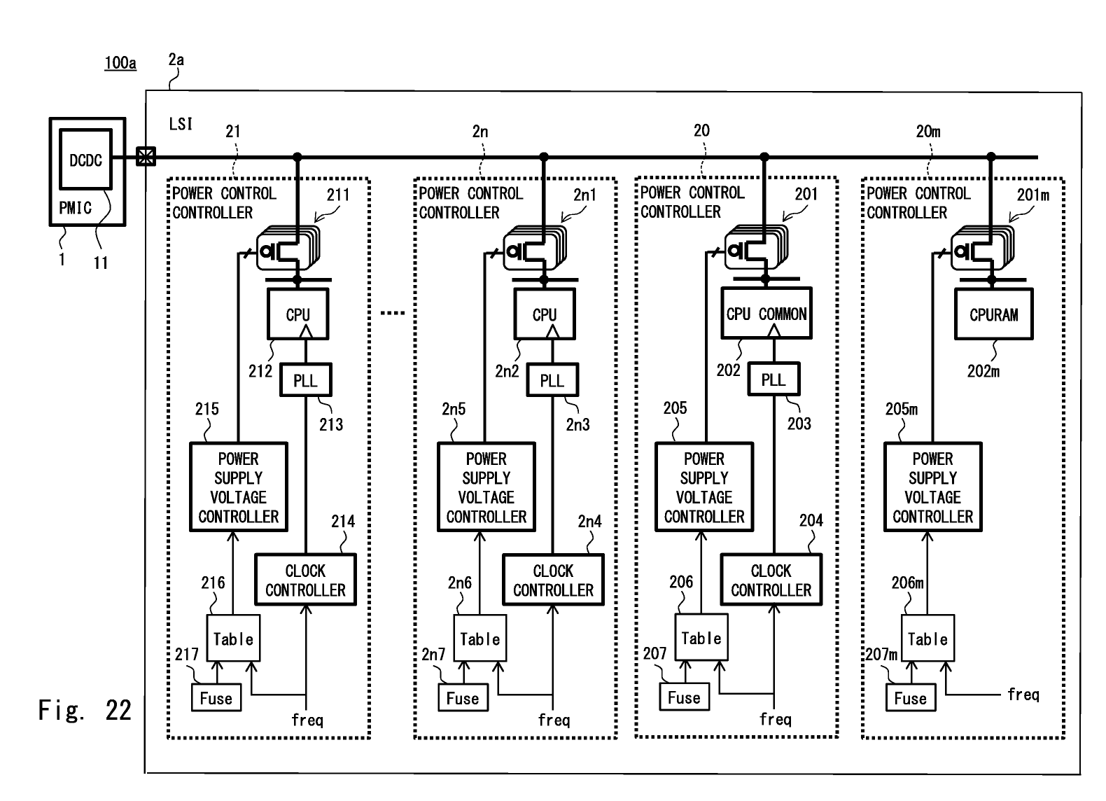

FIG. 22 is a block diagram showing a configuration of a semiconductor system 100a according to a third embodiment. A difference between the semiconductor system 100a and the above-described semiconductor system 100 is that the LSI 2 of the semiconductor system 100 is replaced with an LSI 2a of the semiconductor system 100a. Further, LSI 2a further includes a power control controller 20m in addition to the components of the LSI 2.

The power control controller 20m includes a pMOS group 201m, a CPURAM 202m, a power supply voltage controller 205m, a target voltage value setting table 206m, and a fuse 207m. The CPURAM 202m is a primary cache area of the CPU core 212. Therefore, although supply of a clock is not shown in the drawing, it is assumed that a clock for the CPU core 212 is also supplied to the CPURAM 202m. Although the pMOS group 201m, power supply voltage controller 205m, target voltage value setting table 206m, and fuse 207m have the same functions as the pMOS group 211, power supply voltage controller 215, target voltage value setting table 216, and fuse 217, respectively, they are independent from the components in the power control controller 21.

Therefore, while the power supply voltages to be supplied to the CPU cores 212 . . . 2n2 and CPU common 202 can be varied independently from one another, the power supply voltage to be supplied to the CPURAM 202m can be a fixed voltage. For example, an SRAM (Static Random Access Memory), which is an example of the CPURAM 202m, has a characteristic that it is difficult to lower the power supply voltage supplied thereto. Accordingly, it is possible to achieve appropriate power supply by adjusting the power supply voltage by separately controlling the power supply voltage supplied to the CPURAM 202m from one supplied to the CPU core 212 instead of supplying a variable power supply voltage to the CPURAM 202m unlike the CPU core 212 supplied with a variable power supply voltage.

Further, it is obvious that not only in the CPU core 212 but also for each primary cache area within the corresponding CPU cores 222 to 2n2, the power supply voltage can be adjusted independently from the corresponding cores. In that case, the pMOS group 201m, the power supply voltage controller 205m, the target voltage value setting table 206m, and the fuse 207m may be shared between the respective primary cache areas. By doing so, the circuit size can be reduced.

### Other Embodiments

Although in the above embodiments, the CPU core is explained as the processor core. However, in other embodiments, other IP (Intellectual Property) cores such as a GPU (Graphics Processing Unit) core may be used in place with a CPU core.

In the above embodiments, although pMOSs are used as the switch transistors, it is not limited to this, and instead nMOSs (negative Channel Metal Oxide Semiconductors) may be used. If a difference between the supply voltage VDD and control voltage VDDM is about 0.1 V, pMOSs are preferable. However, if the difference between the supply voltage VDD and control voltage VDDM is greater than 0.1 V, for example, about 1 V, nMOSs may be used in place of pMOSs.

The above embodiments can be applied to a power control controller, semiconductor device, and semiconductor system to be mounted on vehicles. For example, the conductive type (p-type or n-type) of a semiconductor substrate, a semiconductor layer, and a diffusion layer (diffusion region) etc. may be inverted in the semiconductor devices according to the above embodiments. Therefore, when one of the conductive types of n-type and p-type is referred to as a first conductive type, and the other one of the conductive types of n-type and p-type is referred to as a second conductive type, the first conductive type may be p-type, and the second conductive type may be n-type. Alternatively, the first conductive type may be n-type, and the second conductive type may be p-type.

Further, in the above embodiments, the embodiments are described as a configuration of hardware, however the embodiments are not limited to this. In the embodiments, the processes can be achieved by causing a processor such as CPU (Central Processing Unit) to execute a computer program.

In the above-described example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray(registered trademark) Disc), and semiconductor memories (such as mask ROM, PROM (programmable ROM), EPROM (erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the embodiments disclosed above can be described as, but not limited to, the following supplementary notes.

### (Supplementary Note 1)

A power control controller comprising:

a plurality of switch transistors connected in parallel between a supply voltage line and a control voltage line;

an analog-to-digital converter configured to convert a control voltage output from the control voltage line into a current voltage value, the current voltage value being a digital value; and

a step-down controller configured to control the plurality of switch transistors in order to bring the converted current voltage value close to a target voltage value.

### (Supplementary Note 2)

The power control controller according to Supplementary note 1, further comprising:

a monitoring unit configured to monitor an operation state of a processor core; and

a target voltage controller configured to output the target voltage value to the step-down controller, wherein

when the operation state satisfies a predetermined condition, the monitoring unit outputs an instruction for increasing or decreasing the target voltage value to the target voltage controller, and

the target voltage controller controls the increase or decrease of the target voltage value according to the instruction for the increase or the decrease and outputs the increased or decreased target voltage value to the step-down controller.

### (Supplementary Note 3)

The power control controller according to Supplementary note 2, wherein the monitoring unit includes a first monitor that, when a temperature of the processor core falls below a predetermined value, outputs a first instruction for increasing the target voltage value to the target voltage controller as the instruction for the increase or the decrease.

### (Supplementary Note 4)

The power control controller according to Supplementary note 3, wherein the monitoring unit includes a second monitor that, when a delay of each transistor inside the processor core exceeds a predetermined range, outputs a second instruction for increasing or decreasing the target voltage value to the target voltage controller as the instruction for the increase or the decrease.

### (Supplementary Note 5)

The power control controller according to Supplementary note 4, wherein

the second monitor is configured to output the second instruction when the first instruction is not output by the first monitor, and

a value of the increase or the decrease for the target voltage value in the second instruction is greater than that in the first instruction.

### (Supplementary Note 6)

The power control controller according to Supplementary note 2, further comprising a storage unit configured to store a plurality of target voltage values each associated with a combination of a fuse setting value and a clock frequency, wherein

the target voltage controller selects the target voltage value associated with the combination of the input fuse setting value and the input clock frequency among the plurality of target voltage values, controls the increase or the decrease of the selected target voltage value according to the instruction for the increase or the decrease, and outputs the increased or decreased target voltage value to the step-down controller.

### (Supplementary Note 7)

The power control controller according to Supplementary note 6, wherein

the monitoring unit includes a third monitor that outputs a third instruction for excluding, from the selection, the target voltage value associated with the combination of a higher one of the clock frequency from among the combinations according to a state of deterioration of the processor core to the storage unit, and

the target voltage controller selects the target voltage value associated with the combination of the input fuse setting value and the input clock frequency from among the target voltage values excluding the target voltage value excluded from the selection from among the plurality of target voltage values.

### (Supplementary Note 8)

The power control controller according to Supplementary note 1, further comprising a power block controller that performs an AND operation on output of the step-down controller and controls to turn on/off for each of the plurality of switch transistors.

### (Supplementary Note 9)

The power control controller according to Supplementary note 8, wherein

the step-down controller controls all the plurality of the switch transistor to be turned on when the power control controller is powered on, and

the power block controller controls the plurality of switch transistor to be turned on in a plurality of times when the power control controller is powered on.

### (Supplementary Note 10)

The power control controller according to Supplementary note 9, wherein the power block controller controls some of the plurality of switch transistors to be turned on in a plurality of times when the power control controller is powered on, and then controls the remaining switch transistors to be collectively turned on.

### (Supplementary Note 11)

A semiconductor device comprising a plurality of power control controllers, wherein each of the plurality of power control controller comprises:

a processor core;

a plurality of switch transistors connected in parallel between a supply voltage line and a control voltage line, the control voltage line supplying a power supply voltage to the processor core;

an AD converter configured to convert a control voltage output from the control voltage line into a current voltage value, the current voltage value being a digital value;

a storage unit configured to store a plurality of target voltage values each associated with a combination of a fuse setting value and a clock frequency; and

a step-down controller configured to control the plurality of switch transistors in order to bring the converted current voltage value close to a target voltage value selected from among the plurality of target voltage values, wherein a plurality of the storage units included respectively in the plurality of power control controller have different specified values from one another.

### (Supplementary Note 12)

The semiconductor device according to Supplementary note 11, wherein a power supply voltage different from a power supply voltage supplied to other components in the processor core is supplied to the storage area in the processor core.

### (Supplementary Note 13)

A semiconductor system comprising:

a semiconductor device comprising a plurality of power control controllers, each of the plurality of power control controller comprising:
a processor core;
a plurality of switch transistors connected in parallel between a supply voltage line and a control voltage line, the control voltage line supplying a power supply voltage to the processor core;
an AD converter configured to convert a control voltage output from the control voltage line into a current voltage value, the current voltage value being a digital value; and
a step-down controller configured to control the plurality of switch transistors in order to bring the converted current voltage value close to a target voltage value; and

a power supply device configured to supply a fixed voltage to the supply voltage line.

### (Supplementary Note 14)

A power control method of a power control controller comprising a plurality of switch transistors connected in parallel between a supply voltage line and a control voltage line, the power control method comprising:

converting a control voltage output from the control voltage line into a current voltage value, the current voltage value being a digital value; and

controlling the plurality of switch transistors in order to bring the converted current voltage value close to a target voltage value.

Although the invention made by the inventor has been described in detail based on the embodiments, it is obvious that the present invention is not limited to the above-described embodiments, and various modifications may be made without departing from the scope of the invention.

The first, second, and third embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A power control controller comprising:
a plurality of switch transistors connected in parallel between a supply voltage line and a control voltage line;
an analog-to-digital converter configured to convert a control voltage output from the control voltage line into a current voltage value, the current voltage value being a digital value; and
a step-down controller configured to control the plurality of switch transistors in order to bring the converted current voltage value close to a target voltage value.

2. The power control controller according to claim 1, further comprising:
a monitoring unit configured to monitor an operation state of a processor core; and
a target voltage controller configured to output the target voltage value to the step-down controller, wherein
when the operation state satisfies a predetermined condition, the monitoring unit outputs an instruction for increasing or decreasing the target voltage value to the target voltage controller, and
the target voltage controller controls the increase or decrease of the target voltage value according to the instruction for the increase or the decrease and outputs the increased or decreased target voltage value to the step-down controller.

3. The power control controller according to claim 2, wherein the monitoring unit includes a first monitor that, when a temperature of the processor core falls below a predetermined value, outputs a first instruction for increasing the target voltage value to the target voltage controller as the instruction for the increase or the decrease.

4. The power control controller according to claim 3, wherein the monitoring unit includes a second monitor that, when a delay of each transistor inside the processor core exceeds a predetermined range, outputs a second instruction for increasing or decreasing the target voltage value to the target voltage controller as the instruction for the increase or the decrease.

5. The power control controller according to claim 4, wherein
the second monitor is configured to output the second instruction when the first instruction is not output by the first monitor, and
a value of the increase or the decrease for the target voltage value in the second instruction is greater than that in the first instruction.

6. The power control controller according to claim 2, further comprising a storage unit configured to store a plurality of target voltage values each associated with a combination of a fuse setting value and a clock frequency, wherein
the target voltage controller selects the target voltage value associated with the combination of the input fuse setting value and the input clock frequency among the plurality of target voltage values, controls the increase or the decrease of the selected target voltage value according to the instruction for the increase or the decrease, and outputs the increased or decreased target voltage value to the step-down controller.

7. The power control controller according to claim 6, wherein
the monitoring unit includes a third monitor that outputs a third instruction for excluding, from the selection, the target voltage value associated with the combination of a higher one of the clock frequency from among the combinations according to a state of deterioration of the processor core to the storage unit, and
the target voltage controller selects the target voltage value associated with the combination of the input fuse setting value and the input clock frequency from among the target voltage values excluding the target voltage value excluded from the selection from among the plurality of target voltage values.

8. The power control controller according to claim 1, further comprising a power block controller that performs an AND operation on output of the step-down controller and controls to turn on/off for each of the plurality of switch transistors.

9. The power control controller according to claim 8, wherein
the step-down controller controls all the plurality of the switch transistor to be turned on when the power control controller is powered on, and
the power block controller controls the plurality of switch transistor to be turned on in a plurality of times when the power control controller is powered on.

10. The power control controller according to claim 9, wherein the power block controller controls some of the plurality of switch transistors to be turned on in a plurality of times when the power control controller is powered on, and then controls the remaining switch transistors to be collectively turned on.

11. A semiconductor device comprising a plurality of power control controllers, wherein each of the plurality of power control controller comprises:
a processor core;
a plurality of switch transistors connected in parallel between a supply voltage line and a control voltage line, the control voltage line supplying a power supply voltage to the processor core;
an AD converter configured to convert a control voltage output from the control voltage line into a current voltage value, the current voltage value being a digital value;
a storage unit configured to store a plurality of target voltage values each associated with a combination of a fuse setting value and a clock frequency; and
a step-down controller configured to control the plurality of switch transistors in order to bring the converted current voltage value close to a target voltage value selected from among the plurality of target voltage values, wherein a plurality of the storage units included respectively in the plurality of power control controllers have different specified values from one another.

12. The semiconductor device according to claim 11, wherein the storage area in the processor core is supplied with a power supply voltage different from a power supply voltage supplied to components other than the storage area in the processor core.

13. A semiconductor system comprising:
a semiconductor device comprising a plurality of power control controllers, each of the plurality of power control controllers comprising:
a processor core;
a plurality of switch transistors connected in parallel between a supply voltage line and a control voltage line, the control voltage line supplying a power supply voltage to the processor core;
an AD converter configured to convert a control voltage output from the control voltage line into a current voltage value, the current voltage value being a digital value; and
a step-down controller configured to control the plurality of switch transistors in order to bring the converted current voltage value close to a target voltage value; and
a power supply device configured to supply a fixed voltage to the supply voltage line.
